(19) United States
(12) Patent Application Publication
(10) Pub. No.: US 2006/0218319 A1
(43) Pub. Date: Sep. 28, 2006

(54) Native USB/FireWire(1394) storage device

(75) Inventor: Itzhak Levy, Hollywood, FL (US)

Correspondence Address: LERNER GREENBERG STEMER LLP, P O BOX 2480, HOLLYWOOD, FL, 33022-2480, US

(73) Assignee: IDE Technologies, Inc.

(21) Appl. No.: 11/086,851

(22) Filed: Mar. 22, 2005

(51) Int. Cl. G06F 13/38

(52) U.S. Cl. 710/62

(57) ABSTRACT

A computer storage device has a native USB/FireWire (1394) connector. In this native USB or FireWire physical storage device, the USB or FireWire (1394) connector is integrated into the storage device control unit. This eliminates the need for a hardware bridge between the serial or parallel ATA/ATAPI storage device and the USB or FireWire host computer port.

### BACKGROUND OF THE INVENTION

### Field of the Invention

The invention lies in the computer technology field. More specifically, the invention relates to a storage device for the computer industry.

The personal computer revolution of the early 1980's created a need for data storage devices with the ability to read/write and modify data as needed by the computer applications. Before the personal computer revolution, data was saved on magnetic ring units that occupied a large space and had a limited capacity and very low performance levels.

With the personal computer revolution, the market demanded a larger storage capacity and more compact sized storage device that could be connected to the computer. The first Personal Computer (PC) that was produced by IBM (International Business Machine) in the early 1980's supported a 5.25″ floppy disk with a limited storage capacity and very poor performance. At the time it was the height of technology.

With the release of the IBM XT, the first Hard File Device—a ST506 5.25″ 10 MB Disk—was introduced in the personal computer market. As software applications began to require more and more storage space and a faster data transfer rate between the computer and the storage device, the computer industry faced a challenge of supplying faster and higher capacity storage devices.

The Computer industry has introduced various types of storage devices such as hard disks, tape drives, Optical disks, CD ROMs, DVD players, removable media (Floppy Drives, Zip drive) with various types of interface formats (ST506, ESDI, IDE, EIDE, ATA, SATA, SCSI, SAS) with the goal of being faster, higher-capacity and more affordable to the user.

Over time, the computer industry settled on the two common mostly used interfaces: SCSI and ATA/ATAPI. The SCSI interface (Small Computer System Interface) has long been considered the highest performance and highest capacity drive interface. For this reason, SCSI disks are used for high performance systems such as servers and workstations. The ATA/ATAPI (Advance Technology Attachment Protocol Interface) interface is a less expensive alternative to the SCSI interface, with a lower performance levels adequate for the personal desktop computer market as well as other moderately sized computer systems (POS, Medical Equipment, web server, etc.). Over time, the ATA/ATAPI storage devices interface has improved to close the gap in performance and capacity with the SCSI interface storage devices.

The early SCSI devices were supported by 50 pin connectors and the ATA/ATAPI by 40 pin connectors. Both storage types are connected via a flat cable to the host computer system. This type of connection is known as parallel connection. The flat parallel cable connection limits the use of these storage devices to internal use due to the limited recommended cable lengths and the complexity of delivering several signals at once.

To overcome some of the problems caused by the flat cable, (noise, cable length, space, speed of data transfer, air flow limitation, etc.) the computer industry recently introduced the SATA (Serial Advanced Technology Attachment) and the SAS (Serial Attachment SCSI), two new interface formats that transfer data through serial connection but follow the same protocols required by ATA/ATAPI and SCSI interfaces respectively. The protocol compatibility is necessary to allow the existing operating systems and software applications to be compatible with the new storage devices without the need for any software modification. This compatibility allowed the industry to quickly and easily adapt to the new serial interface technologies. The serial ATA/ATAPI and SCSI connection, like the parallel connection, is also limited by cable length to internal use.

The need to move large amounts of data from one computer to another and the need for data backup to be stored offsite has created a need in the industry for external storage devices. The parallel and serial interfaces of the SCSI and ATA/ATAPI storage devices limit the use of these devices to internal use due to cable length and power supply limitations and due the fact that these interfaces can not be connected and disconnected (Plug and Play) while the computer system is turned on.

The arrival of FireWire (1394) and USB (universal serial bus) serial protocols has allowed the use of external storage device connection to the personal computer. The FireWire and the USB protocols and hard connection are true plug and play connections. The combination of the FireWire and USB interfaces and the ATA/ATAPI storage devices are a good solution for the use of plug and play external storage devices.

In order to use an ATA/ATAPI storage device externally a bridge between the serial or parallel ATA/ATAPI storage device and the serial USB or FireWire port on the host computer is required. The industry quickly filled this need by developing hardware to serve as the bridge to convert the storage devices parallel or serial ATA signal interface to the computer's serial USB or FireWire protocol and vice versa. There is a tremendous market for external storage devices that connect to the computer in this fashion.

### SUMMARY OF THE INVENTION

It is accordingly an object of the invention to provide a native USB/FireWire (1394) storage device, which overcomes the above-mentioned disadvantages of the heretofore-known devices and methods of this general type and which includes a native USB or FireWire physical storage device where the USB or FireWire connector is integrated into the storage device control unit. This eliminates the need for a hardware bridge between the serial or parallel ATA/ATAPI storage device and the USB or FireWire host computer port.

With the foregoing and other objects in view there is provided, in accordance with the invention, a computer storage device assembly, comprising:

a computer storage device;

a control unit connected to said computer storage device for reading data from said storage device; and

at least one of a native USB connector and FireWire connector configured for receiving a USB or FireWire plug for connecting said control unit to a host computer.

In accordance with an added feature of the invention, the storage device is a read and write capable device.

In accordance with a preferred feature of the invention, the storage device is a device with ATA/ATAPI protocol interface communication.

With the above and other objects in view there is also provided, in accordance with the invention, a computer hard disk drive assembly, consisting essentially of a hard disk, a control unit connected to said hard disk, a power connector, and at least one connector selected from the group consisting of a USB connector and a FireWire connector configured to receive a USB or FireWire cable for connection to a host computer. Preferably, the assembly is configured as a computer-internal disk drive and dimensioned for installation in a standard drive bay.

In accordance with an alternative embodiment of the invention, there is provided an external hard drive assembly, consisting essentially of a computer storage device, a control unit connected to said storage device, a housing enclosing said storage device and said control unit, a power connector mounted to said housing, and at least one connector selected from the group consisting of a native USB connector and a native FireWire connector mounted to said control unit and configured to receive a USB or FireWire cable for connecting said control unit to a host computer.

In accordance with a concomitant feature of the invention, the computer storage device is a hard disk drive device, a CD ROM, and/or a DVD.

### BRIEF DESCRIPTION OF THE DRAWING

FIG. 1 shows a storage device.

FIG. 2 shows the storage device controller unit with electronics components assembled on a PCB.

FIG. 3 shows a parallel ATA/ATAPI (PATA) storage device.

FIG. 4 shows a serial ATA/ATAPI (SATA) storage device.

FIG. 5 shows a USB and FireWire bridge that converts parallel ATA/ATAPI signals to USB and FireWire signals and vice versa.

FIG. 6 shows a parallel ATA/ATAPI storage device connected via a USB bridge to a host computer.

FIG. 7 shows the invention, a storage device integrated with a control unit and a USB and or FireWire connector.

FIG. 8 shows a complete external storage device enclosed in an external enclosure with a USB and or FireWire connectors.

### DESCRIPTION OF THE PREFERRED EMBODIMENTS

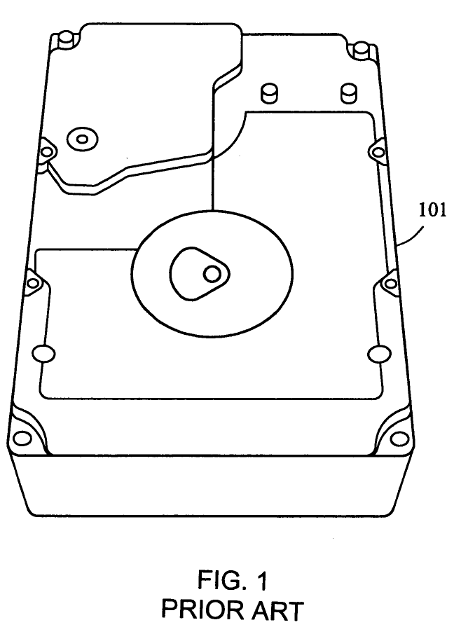

Referring now to the figures of the drawing in detail. FIG. 1 shows a bare storage device 101 without any electronics attached to it. The storage device described in this figure can be a Heads Disk Assembly (HDA) or and type of removable storage device such as a CD-ROM, DVD, tape drive, etc. The figure shows an HDA device that includes magnetic platters, heads and a servo motor protected by a vacuum sealed package to avoid damage from dust and to achieve high speed rotation of the platters. The faster the rotation of the platters, the faster data can be transferred between the HDA, the control unit and the host computer.

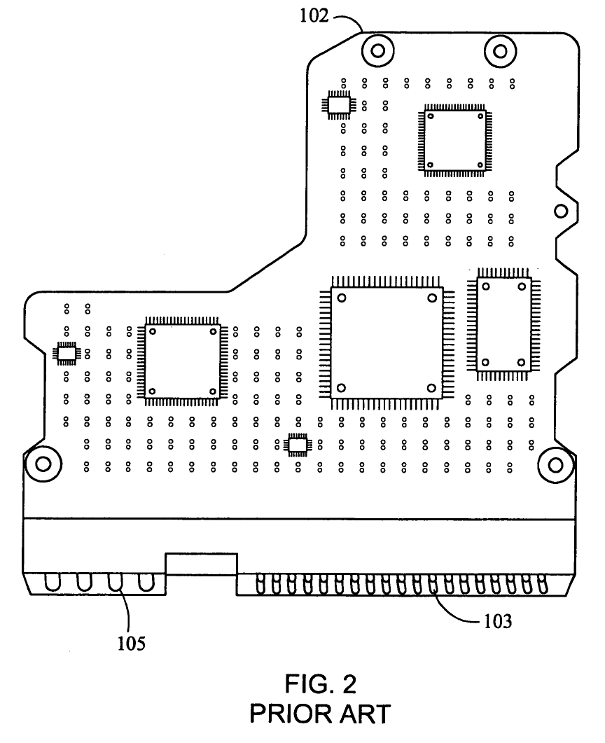

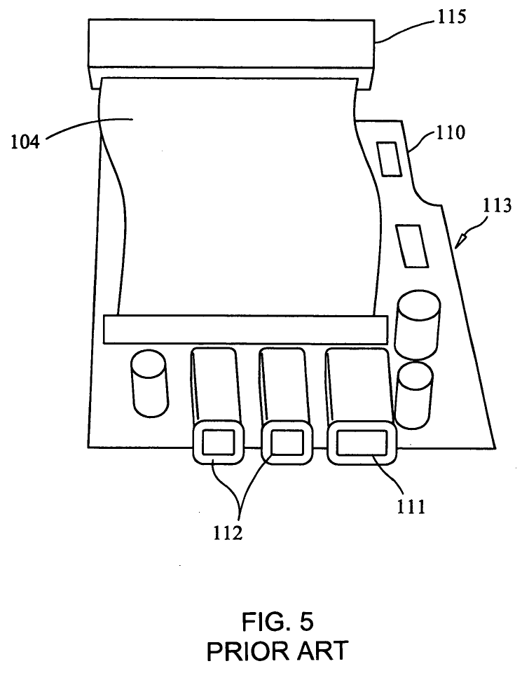

FIG. 2 shows a PCB with electronics forming the Control Unit 102 that includes all components needed to control the storage device 101 for the purpose of transferring data in and out of the storage device 101. The control unit 102 also includes a 40 pin (male) interface connector 103 (Parallel ATA/ATAPI) that is connected via a 40 pin cable 104 (shown at FIG. 5) to the host computer, and a power connector 105 for receiving the power needed to power the control unit 102 and the storage device 101. The control unit 102 can be with any type of interface connection. FIG. 2 shows the 40 pin signal interface connection 103 without any intention of limitation on the storage device interface.

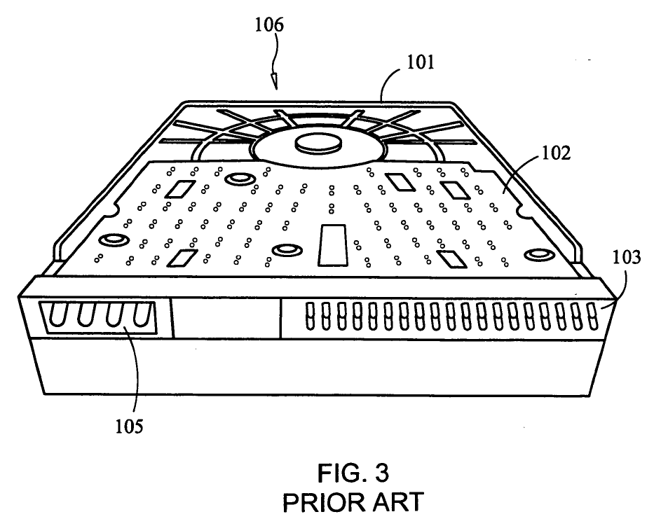

FIG. 3 shows a storage device 101 integrated with a control unit 102 forming a parallel ATA/ATAPI storage device 106 with a 40 pin signal interface connector 103 and the legacy power connector 105.

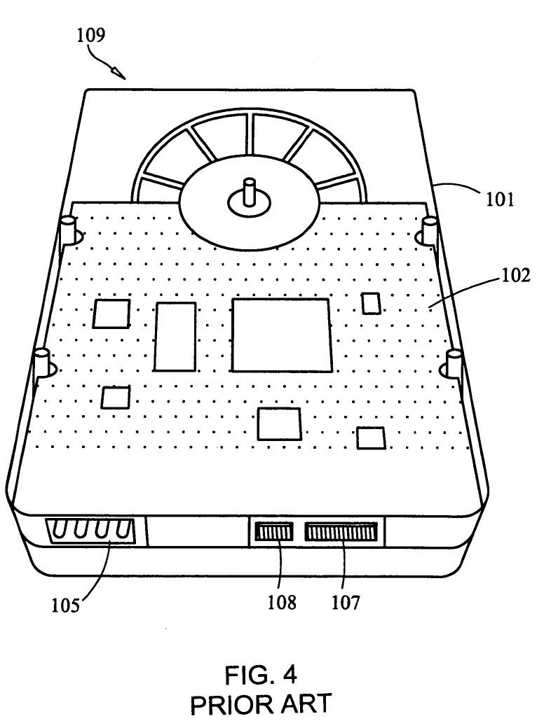

FIG. 4 shows a storage device 101 integrated with a control unit 102 forming a serial ATA/ATAPI storage device 109 with a serial ATA interface connectors 107, 108 that includes the data and power signals and the legacy power connector 105. The reason for this serial ATA/ATAPI storage device 109 having both types of power connectors is for compatibility purposes only. Only one of the power connectors is actually required for operation at any given time.

FIG. 5 shows a USB/FireWire bridge 113 that includes a PCB 110 which includes the electronics components, a USB connector 111 and two FireWire connectors 112, a 40 pin flat cable 104 with a 40 pin (female) connector 115.

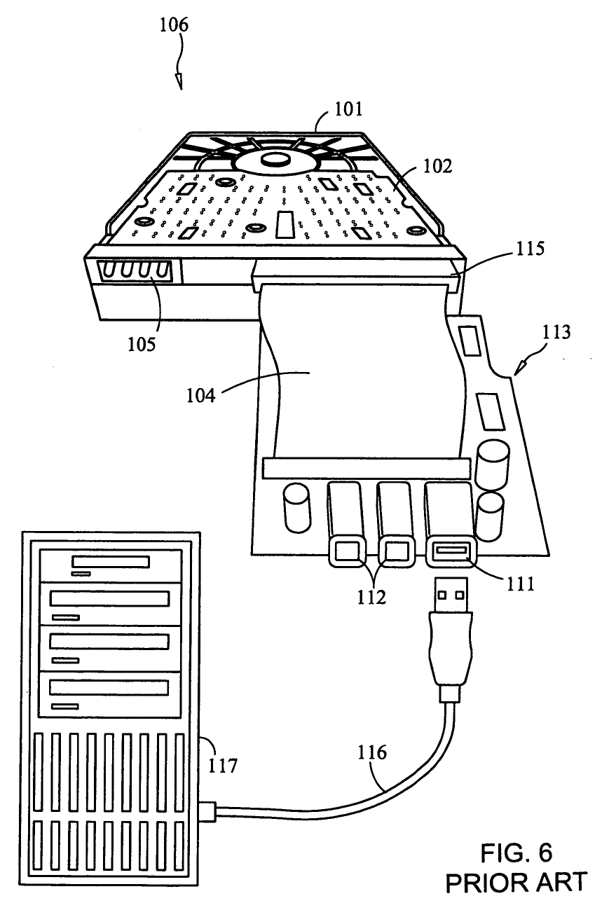

FIG. 6 shows a complete assembly of a parallel ATA 106 and a USB/FireWire bridge 113 to form a storage device to be connected to a computer via a USB connector 111 and or FireWire connector 112. This Figure also shows a USB cable 116 that connects at one end to the USB connector 110 on the bridge and at the other end to the host computer 117 to allow data transfer between the parallel ATA Disk 106 and the computer system.

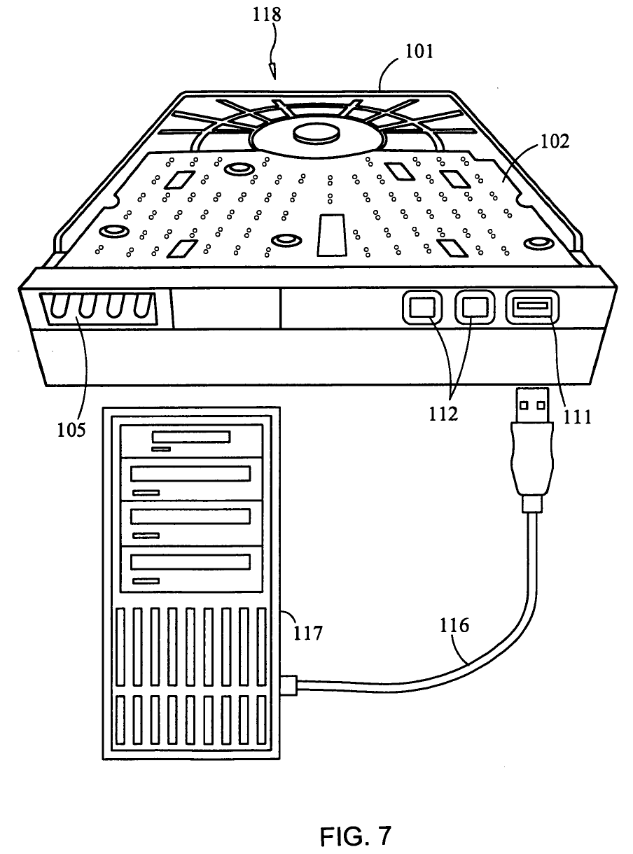

FIG. 7 shows the invention that includes a storage device 101 with a control unit 102 that integrates a USB connector 113 and a FireWire connector 112 forming a native USB and or FireWire storage device 118. The USB and or FireWire native storage device 118 will generate data in the USB and or the FireWire Protocol and transmit/receive data via the USB connector 111 and or the FireWire connector 112.

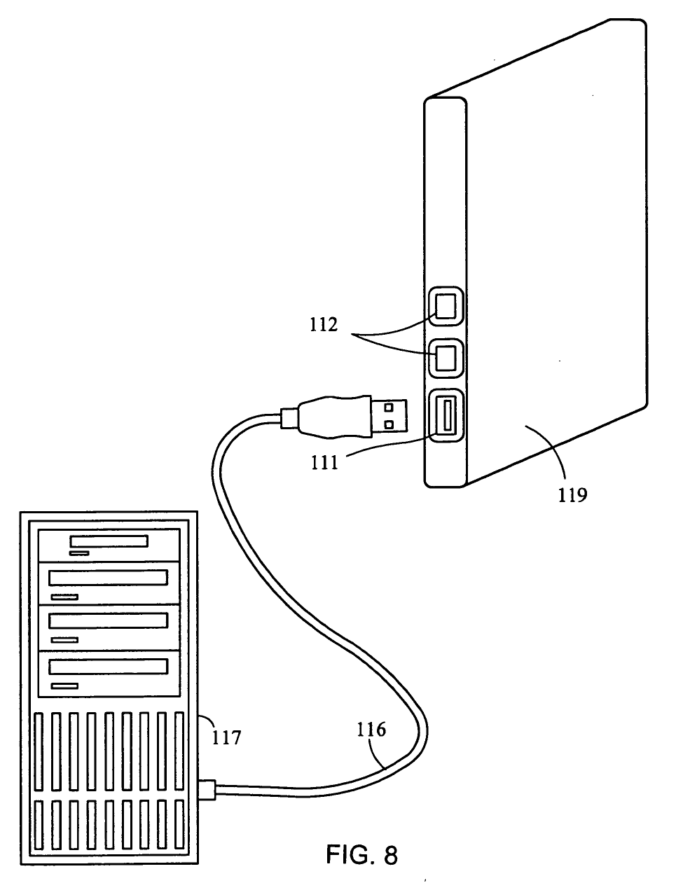

FIG. 8 shows an external storage device in an external enclosure 119 that contains the invention: a native USB/FireWire storage device 118 that is connected to the host computer 117 via a USB cable 116.

I consider herein two distinct implementations of the novel configuration, namely:
The “bridge component” and the USB/FireWire connectors may be integrated on the ATA/ATAPI storage device control unit; or
A new set of components may be configured and/or assembled that will support the storage device heads, the motor and data transfer from one end and the USB and/or FireWire to the other end.

The term “native” as used herein should be understood to include these implementations.

I claim:

1. A computer storage device assembly, comprising:
a computer storage device;
a control unit connected to said computer storage device for reading data from said storage device; and
at least one of a native USB connector and FireWire connector configured for receiving a USB or FireWire plug for connecting said control unit to a host computer.

2. The assembly according to claim 1, wherein said storage device is a read and write capable device.

3. The assembly according to claim 1, wherein said storage device is a device with ATA/ATAPI protocol interface communication.

4. A computer hard disk drive assembly, consisting essentially of a hard disk, a control unit connected to said hard disk, a power connector, and at least one connector selected from the group consisting of a USB connector and a FireWire connector configured to receive a USB or FireWire cable for connection to a host computer.

5. The assembly according to claim 4 configured as a computer-internal disk drive and dimensioned for installation in a standard drive bay.

6. An external hard drive assembly, consisting essentially of a computer storage device, a control unit connected to said storage device, a housing enclosing said storage device and said control unit, a power connector mounted to said housing, and at least one connector selected from the group consisting of a native USB connector and a native FireWire connector mounted to said control unit and configured to receive a USB or FireWire cable for connecting said control unit to a host computer.

7. The assembly according to claim 6, wherein said computer storage device is a hard disk drive device.

8. The assembly according to claim 6, wherein said computer storage device is a storage device selected from the group consisting of a hard disk, a CD ROM, and a DVD.
